(19) United States
(12) Patent Application Publication
(10) Pub. No.: US 2015/0363987 A1
(43) Pub. Date: Dec. 17, 2015

(54) OPERATION INPUT CONFIRMATION DEVICE, AND VEHICLE DOOR HANDLE DEVICE

(71) Applicant: AISIN SEIKI KABUSHIKI KAISHA, Kariya-shi, Aichi (JP)

(72) Inventors: Hiroshi KIRIYAMA, Nagoya-shi (JP); Takehiro TABATA, Kariya-shi (JP); Masahiro HAGIMOTO, Nagoya-shi (JP); Eiji MUSHIAKE, Chita-gun (JP); Katsuyoshi SHIRAI, Anjo-shi (JP)

(73) Assignee: AISIN SEIKI KABUSHIKI KAISHA, Kariya-shi, Aichi-ken (JP)

(21) Appl. No.: 14/765,210

(22) PCT Filed: Feb. 13, 2014
(86) PCT No.: PCT/JP2014/053364

§ 371 Date: Jul. 31, 2015

(30) Foreign Application Priority Data
Feb. 26, 2013 (JP) 2013-036081

(51) Int. Cl. G07C 9/00

(52) U.S. Cl. CPC G07C 9/00126

(57) ABSTRACT

An operation input confirmation device includes an operation input section configured to be used for locking/unlocking a vehicle door, an operation input detector, which detects the occurrence of an operation input to the operation input section, a locking-unlocking confirmation section, which generates a locking-unlocking confirmation output indicating execution of locking/unlocking corresponding to the operation input, and an operation confirmation section, which generates an operation confirmation output indicating the occurrence of the operation input in response to the detection of the occurrence of the operation input without waiting for execution of the locking/unlocking.

### TECHNICAL FIELD

The present invention relates to an operation input confirmation device and a vehicle door handle device.

### BACKGROUND ART

Conventionally, some vehicles include an operation input confirmation function that allows a user to confirm a locking-unlocking operation by outputting, for example, sound, light, or vibration when the user locks or unlocks a vehicle door. For example, refer to Patent Document 1.

Such a vehicle includes, for example, an electronic key system, which determines whether a portable device is an authorized one, that is, whether the occupant holding the portable device is an authorized user, by wireless communication between the portable device and an electronic control unit (ECU) of the vehicle. The electronic key system, in many cases, includes an operation input section for locking/unlocking the vehicle door on a door handle of the vehicle. Upon receipt of an operation input to the operation input section, the vehicle door is locked or unlocked, and a locking-unlocking confirmation output (answer back), which indicates execution of locking/unlocking, is generated.

### PRIOR ART DOCUMENT

### Patent Document

Patent Document 1: Japanese Laid-Open Patent Publication No. 2008-240415

### SUMMARY OF THE INVENTION

### Problems that the Invention is to Solve

However, as shown in FIG. 10, there is conventionally a temporal delay (time lag) from occurrence of the operation input (T1) by the user to generation of the locking-unlocking confirmation output (T3). That is, the locking-unlocking confirmation output is generated after the occurrence of the operation input by the user is detected (T2) and, moreover, after the process for locking/unlocking the vehicle door has been performed (T3). Furthermore, a filtering process for avoiding a malfunction caused by, for example, a raindrop is executed (filtering time LT1) between the occurrence of the operation input (T1) and the detection (T2). Thus, it is difficult for the user to determine whether the operation input is properly recognized by the vehicle ECCU. In this respect, the locking-unlocking confirmation performed by the conventional electronic key system is susceptible to improvement.

Accordingly, it is an objective of the present invention to provide an operation input confirmation device and a vehicle door handle device that allow a user to promptly confirm an operation input.

### Means for Solving the Problems

To achieve the foregoing objective and in accordance with one aspect of the present invention, an operation input confirmation device is provided that includes an operation input section configured to be used for locking/unlocking a vehicle door, an operation input detector, which detects occurrence of an operation input to the operation input section, a locking-unlocking confirmation section, which generates a locking-unlocking confirmation output indicating execution of locking/unlocking corresponding to the operation input, and an operation confirmation section, which generates an operation confirmation output indicating the occurrence of the operation input in response to the detection of the occurrence of the operation input without waiting for execution of locking/unlocking.

In accordance with another aspect of the present invention, an operation input confirmation device is provided that includes an operation input detector configured to detect occurrence of an operation input to an operation input section configured to be used for locking/unlocking a vehicle door, a locking-unlocking confirmation section, which generates a locking-unlocking confirmation output indicating execution of locking/unlocking corresponding to the operation input, and an operation confirmation section, which generates an operation confirmation output indicating the occurrence of the operation input in response to the detection of the occurrence of the operation input without waiting for execution of locking/unlocking.

### BRIEF DESCRIPTION OF THE DRAWINGS

FIG. 1 is a perspective view of a vehicle door to which an operation input confirmation device according to one embodiment is applied;

FIG. 2 is a block diagram showing the schematic configuration of the operation input confirmation device;

FIG. 3 is a schematic diagram of the door handle to which the operation input confirmation device is applied;

FIG. 4 is a timing diagram showing the manner of operation input confirmation control;

FIG. 5 is a flowchart showing the routine of the operation input confirmation control;

FIG. 6 is a schematic diagram of a vehicle door according to a modified embodiment;

FIG. 7 is a timing diagram showing the manner of operation input confirmation control according to another modified embodiment;

FIG. 8 is a flowchart showing the routine of operation input confirmation control according to a modified embodiment;

FIG. 9 is a flowchart showing the routine of operation input confirmation control according to another modified embodiment; and

FIG. 10 is a timing diagram showing the manner of conventional input confirmation control.

### MODES FOR CARRYING OUT THE INVENTION

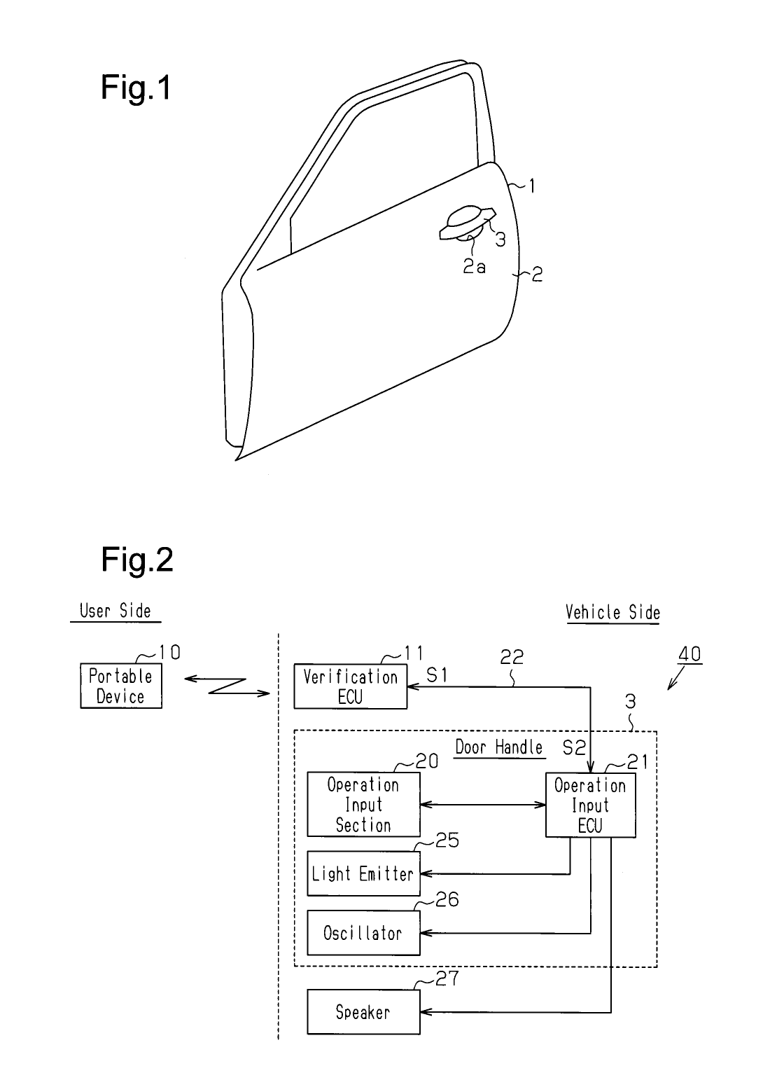

An operation input confirmation device according to one embodiment mounted on a vehicle door handle will now be described with reference to FIGS. 1 to 5.

As shown in FIG. 1, a vehicle door 1 has an outer panel 2, on which a door handle 3 is provided. The door handle 3 serves as a gripping portion when the vehicle door 1 is opened or closed. In the present embodiment, the surface of the outer panel 2 has a recess 2a. The door handle 3 has a substantially rod-like curved outer shape and extends in a vehicle fore-and-aft direction across the recess 2a.

The vehicle door 1 is mounted on a vehicle. As shown in FIG. 2, in the vehicle, wireless communication is performed between a portable device 10 held by the user and a verification ECU 11 mounted on the vehicle for individual authentication. That is, an electronic key system is established in the vehicle. The electronic key system determines whether the portable device 10 is an authorized one, that is, whether the user holding the portable device 10 is an authorized user, by wireless communication between the verification ECU 11 of the vehicle and the portable device 10. The door handle 3 includes an operation input section 20 configured to be used by the user for locking/unlocking the vehicle door 1 with the electronic key system and an operation input ECU 21, which serves as an operation input detector configured to detect occurrence of an operation input to the operation input section 20.

More specifically, the operation input ECU 21 of the present embodiment is connected to the verification ECU 11 through an in-vehicle network 22. The operation input ECU 21 outputs the detected operation input to the verification ECU 11 as an operation input detection signal S1.

That is, on the basis of the operation input detection signal S1 received from the operation input ECU 21, the verification ECU 11 recognizes a locking-unlocking operation of the vehicle door 1 by the user. On the basis of the verification result by wireless communication with the portable device 10, the verification ECU 11 determines whether to execute the required locking-unlocking process of the vehicle door 1.

Furthermore, when the verification ECU 11 executes the locking-unlocking process of the vehicle door 1, the verification ECU 11 outputs a locking-unlocking execution signal S2 indicating such information to the operation input ECU 21. Upon receipt of the locking-unlocking execution signal S2, the operation input ECU 21 generates a locking-unlocking confirmation output (answer back), which indicates the execution of locking/unlocking corresponding to the detected operation input. The operation input ECU 21 corresponds to a locking-unlocking confirmation section.

More specifically, the door handle 3 of the present embodiment has a light emitter (light-emitting diode: LED) 25 and an oscillator (piezoelectric element) 26. The operation input ECU 21 is connected to the light emitter 25 and the oscillator 26. The operation input ECU 21 of the present embodiment is also connected to a speaker 27 provided on the vehicle body (not shown). The operation input ECU 21 generates the locking-unlocking confirmation output by controlling operation of the light emitter 25, the oscillator 26, and the speaker 27. The light emitter 25, the oscillator 26, and the speaker 27 each correspond to a confirmation output section.

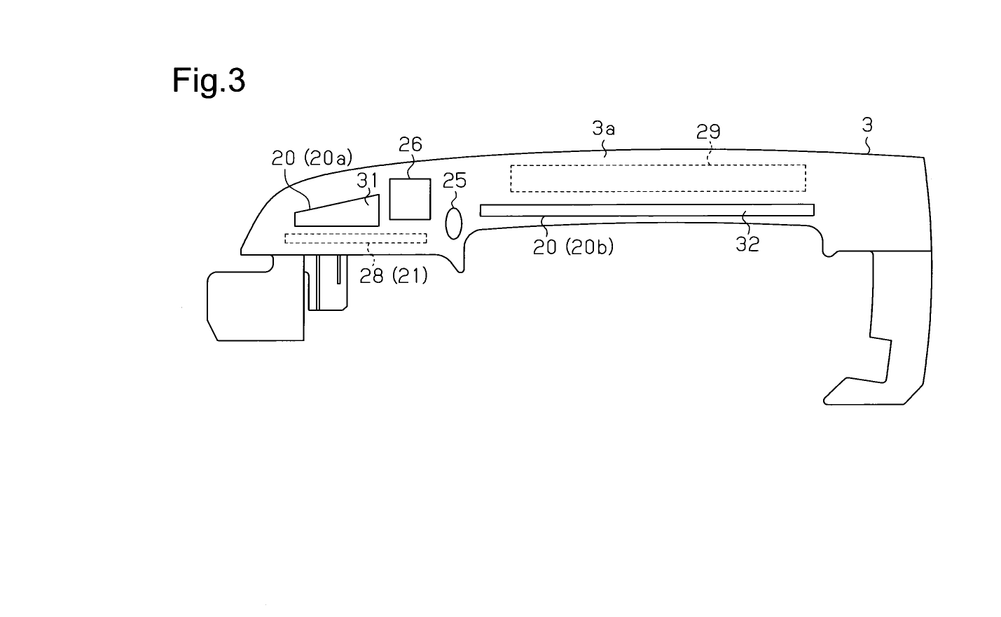

More specifically, as shown in FIG. 3, a control board 28, which contains the operation input ECU 21, is incorporated in the door handle 3 of the present embodiment. In addition, an antenna (transmission antenna) 29 used for wireless communication between the portable device 10 and the verification ECU 11 is mounted on the door handle 3 together with the light emitter 25 and the oscillator 26. Furthermore, capacitive sensor electrodes 31, 32 that form the operation input section 20 are provided on the surface of the door handle 3.

In other words, in the present embodiment, the capacitive sensor electrodes 31, 32 and the operation input ECU 21 configure a capacitive touch sensor. More specifically, a first capacitive sensor electrode 31 forms a locking operation input section 20a in the vicinity of the front end portion of the door handle 3 (left end in FIG. 3). Furthermore, a second capacitive sensor electrode 32 forms an unlocking operation input section 20b in the extending direction of a rod-like hand grip portion 3a. The operation input ECU 21 is configured to detect occurrence of an operation input for locking or unlocking the vehicle door on the basis of whether the user is in contact with the operation input section 20 (20a, 20b).

The operation input ECU 21 of the present embodiment generates the locking-unlocking confirmation output on the basis of the locking-unlocking execution signal S2 received from the verification ECU 11 as described above. Without waiting for the execution of locking/unlocking, the operation input ECU 21 generates an operation confirmation output, which indicates the occurrence of the operation input in response to detection of the occurrence of the operation input to the operation input section 20 (20a, 20b). The operation input ECU 21 corresponds to an operation confirmation section.

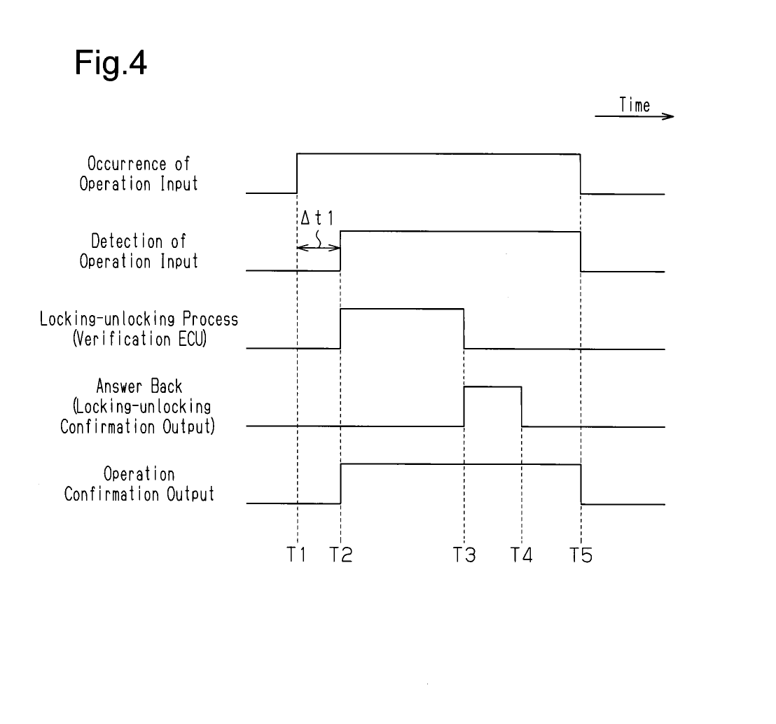

That is, as shown in FIG. 4, after occurrence of the operation input (T1) by the user and at the point in time when the occurrence of the operation input is detected (T2), the operation input ECU 21 of the present embodiment generates the operation confirmation output in a control manner different from that of the locking-unlocking confirmation output using at least one of the light emitter 25, the oscillator 26, and the speaker 27. The different control manner includes arbitrarily varying the light of the light emitter 25 (for example, the flashing speed, the flashing rhythm, the color, and the luminous intensity), arbitrarily varying the vibration of the oscillator 26 (for example, the vibration cycle, the vibration rhythm, and the magnitude of vibration), arbitrarily varying the sound of the speaker 27 (for example, the tone and the volume), and any combination of the above. The operation input ECU 21 is configured to subsequently generate the locking-unlocking confirmation output indicating the execution of locking/unlocking at the point in time when the locking-unlocking execution signal S2 is received from the verification ECU 11 (T3).

In FIG. 4, the time lag from time T1 to time T2 is the time required for the filtering process, which is performed to avoid a malfunction (filtering time LT1). Furthermore, in the present embodiment, the locking-unlocking confirmation output is stopped after a predetermined time has elapsed (from T3 to T4). The operation confirmation output is continued until the user stops the operation input (T5).

Operation of the operation input confirmation device 40 configured as described above, that is, the routine of operation input confirmation control executed by the operation input ECU 21 will now be described.

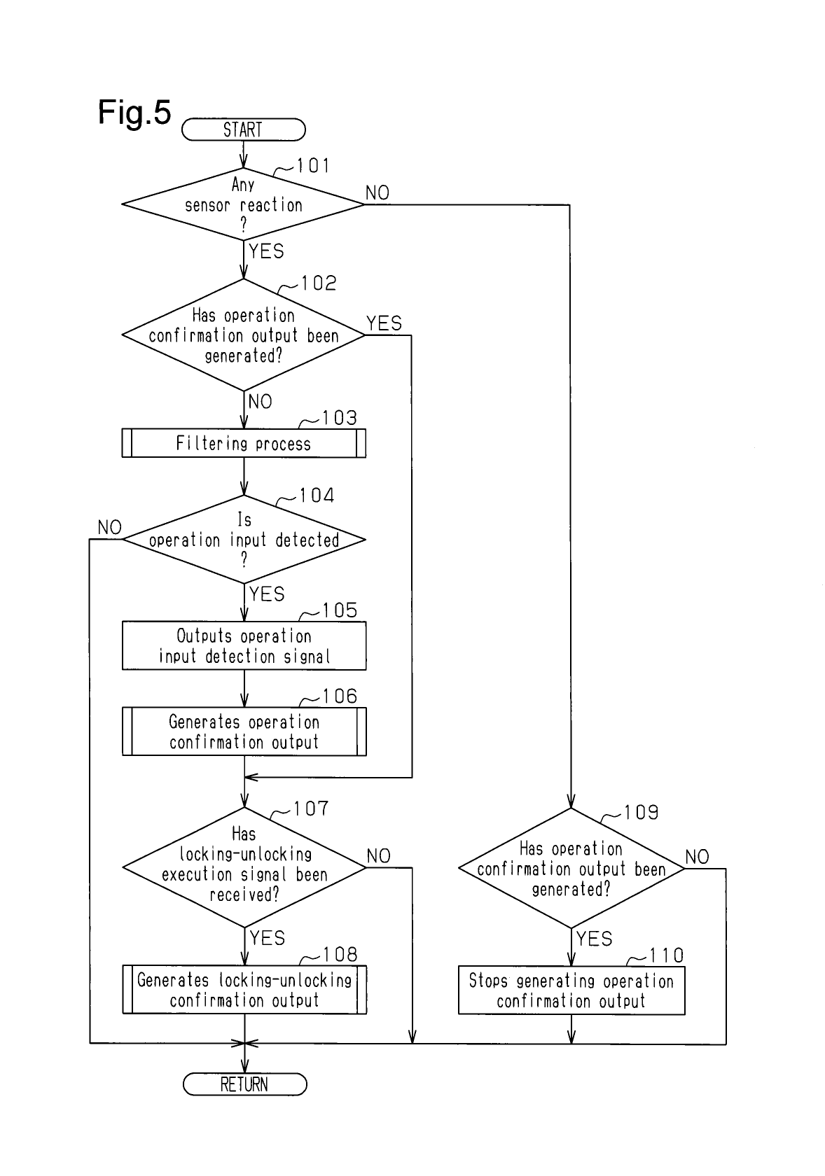

As shown in the flowchart of FIG. 5, the operation input ECU 21 determines whether there is any reaction in the touch sensor formed by the operation input ECU 21 and the capacitive sensor electrodes 31, 32 (step 101). If there is any reaction in the touch sensor (step 101: YES), the operation input ECU 21 first determines whether the operation confirmation output has already been generated (step 102). If the operation confirmation output has not been generated (step 102: NO), the operation input ECU 21 executes the filtering process (step 103) for determining whether the sensor reaction is caused by the operation input of the user to the operation input section 20 (20a, 20b).

The operation input ECU 21 then determines whether occurrence of the operation input by the user has been detected (step 104) by executing the filtering process in step 103. If the occurrence of the operation input by the user has been detected (step 104: YES), the operation input ECU 21 outputs the operation input detection signal S1 indicating that the occurrence of the operation input has been detected to the verification ECU 11 (step 105). At substantially the same time as the output of the operation input detection signal S1, the operation input ECU 21 generates operation confirmation output indicating that the occurrence of the operation input by the user has been detected (step 106).

Upon receipt of the locking-unlocking execution signal S2 from the verification ECU 11 (step 107: YES), the operation input ECU 21 subsequently generates the locking-unlocking confirmation output indicating that locking/unlocking has been executed (step 108).

In step 102, if it is determined that operation confirmation output has already been generated (step 102: YES), the operation input ECU 21 does not execute the processes of step 103 to step 106. Furthermore, if it is determined in step 104 that the sensor reaction is caused by a false detection (step 104: NO), the operation input ECU 21 does not execute the processes of step 105 to step 108. If the locking-unlocking execution signal S2 is not received in step 107 (step 107: NO), the operation input ECU 21 does not execute the process of step 108.

If it is determined that the sensor has not reacted in step 101 (step 101: NO), the operation input ECU 21 determines whether operation confirmation output has already been generated (step 109). If operation confirmation output has already been generated (step 109: YES), the operation input ECU 21 stops generating the operation confirmation output (step 110).

The present embodiment achieves the following advantages.

(1) The door handle 3 includes the operation input section 20, which is used by the user to lock/unlock the vehicle door 1, and the operation input ECU 21, which detects occurrence of an operation input to the operation input section 20. The operation input ECU 21 generates the locking-unlocking confirmation output (answer back) indicating execution of locking/unlocking that corresponds to the detected operation input. In addition to the locking-unlocking confirmation output, the operation input ECU 21 generates operation confirmation output indicating the occurrence of the operation input in response to the detection of the occurrence of the operation input without waiting for the execution of locking/unlocking.

According to the above configuration, the user can promptly confirm the operation input. This further improves the convenience of the user.

(2) The capacitive sensor electrodes 31, 32, which form the operation input section 20, are located on the surface of the door handle 3. That is, in the case of using the capacitive touch sensor to form the operation input section 20, the vehicle door 1 can be easily locked/unlocked by, for example, only touching the surface of the hand grip portion 3a. However, it is hard for the user to feel the response to the operation input. Thus, a more significant advantage is obtained by applying the configuration described in the above advantage (1) to the present configuration.

(3) The operation confirmation output is continued until the operation input by the user is stopped. This allows the user to confirm the continuous operation input (press-and-hold operation). This further improves the convenience of the user.

The above illustrated embodiment may be modified as follows.

The operation input confirmation device 40 of the above described embodiment is mounted on the vehicle door handle 3. However, any of the components of the operation input confirmation device 40, that is, any of the operation input section 20, the confirmation output section (the light emitter 25 and the oscillator 26), and the operation input ECU 21, which configures the operation input detector, the locking-unlocking confirmation section, and the operation confirmation section, may be provided at a position other than the door handle 3. For example, direction indicator lamps on the door mirrors may be used as the light emitter 25. Alternatively, the operation input section 20 may be provided on the body or the panel surface of the vehicle door 1. In this case, the oscillator 26 is preferably provided at the same position as the operation input section 20. Furthermore, the operation input ECU 21 may be arranged in the body or the vehicle door 1. All the elements configuring the operation input confirmation device 40 may be provided at positions other than the door handle 3. The speaker 27 may also be provided in the door handle 3.

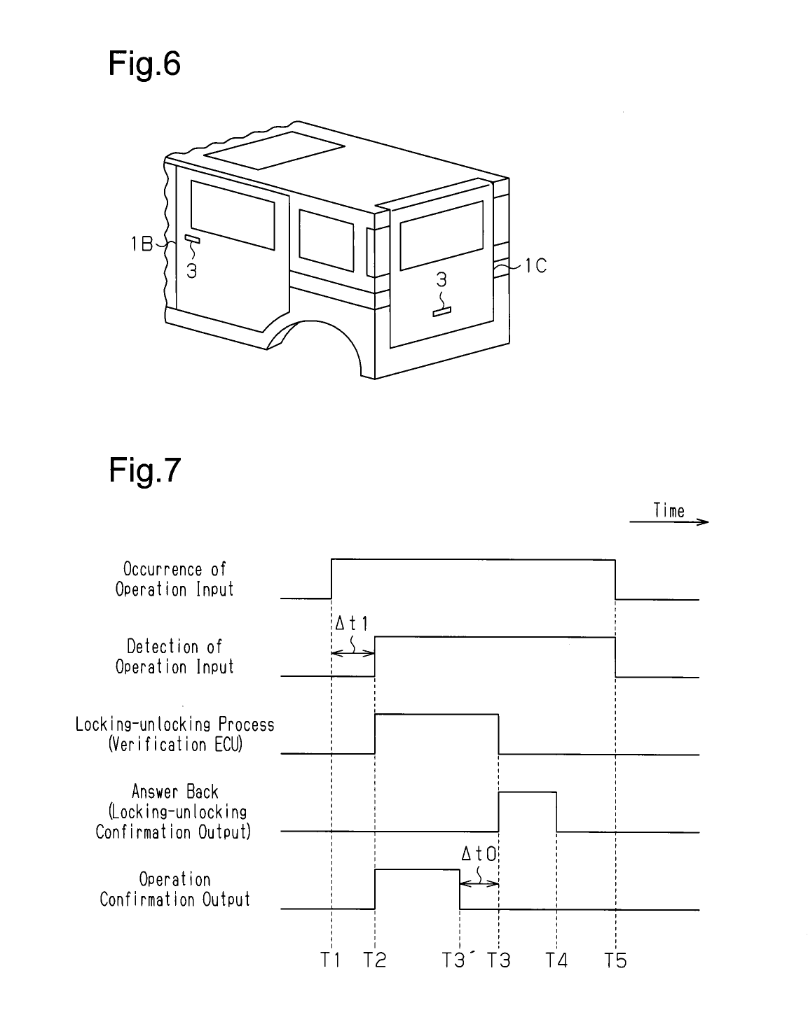

The vehicle door 1 may be any type of door such as a sliding vehicle door 1B shown in FIG. 6 or a flip-up vehicle door (back door) 1C in addition to the door that rotates with a support portion (hinge) serving as a fulcrum as shown in FIG. 1. The shape of the door handle 3 may also be any shape.

In the above illustrated embodiment, the operation input section 20 is configured by using the capacitive touch sensors (the capacitive sensor electrodes 31, 32), but may be modified as necessary. For example, a piezoelectric touch sensor may be used, or a contact push button switch may be used. The operation input section 20 may be configured to be capable of receiving an operation input through an infrared ray or radio transmission.

Furthermore, the light emitter 25 does not necessarily need to be an LED. Similarly, for example, the oscillator 26 may also be changed to any element that generates vibration such as an ultrasonic wave oscillator instead of the piezoelectric element. The operation input section 20 and the oscillator 26 may be formed integrally. In this case, for example, the metal part (frame portion) of the oscillator 26 may be used for the capacitive sensor electrode.

Furthermore, the manner for controlling the confirmation output section, that is, the manner for controlling the light emitter 25, the oscillator 26, and the speaker 27 in the locking-unlocking confirmation output and the operation confirmation output may be changed as necessary. However, the difference between the locking-unlocking confirmation output and the operation confirmation output is desirably easy to be distinguished by the user. Furthermore, the user may be allowed to set the manner for controlling the locking-unlocking confirmation output and the operation confirmation output. For example, the user may be allowed to switch on and off the locking-unlocking confirmation output and the operation confirmation output. Alternatively, the user may be allowed to set a predetermined time during which the locking-unlocking confirmation output is executed.

The locking-unlocking confirmation output and the operation confirmation output may be any light that can be visually confirmed by the user, any vibration that can be sensed by the user, any sound that is audible to the user, or any combination of the above.

In the above illustrated embodiment, the operation confirmation output is continued until the operation input by the user is stopped. Thus, the operation confirmation output and the locking-unlocking confirmation output (answer back) may overlap (refer to T3 to T4 in FIG. 4). However, as shown in FIG. 7, the locking-unlocking confirmation output may be generated (T3) after stopping the operation confirmation output (T3′). With this configuration, the user easily distinguishes the operation confirmation output from the locking-unlocking confirmation output. This increases the convenience for the user.

Furthermore, the locking-unlocking confirmation output may be executed at a predetermined interval ΔT0 after stopping the operation confirmation output. This allows the user to more easily distinguish the operation confirmation output from the locking-unlocking confirmation output.

Furthermore, the operation confirmation output may be generated in a different control manner depending on whether the detected operation input is a locking operation or an unlocking operation.

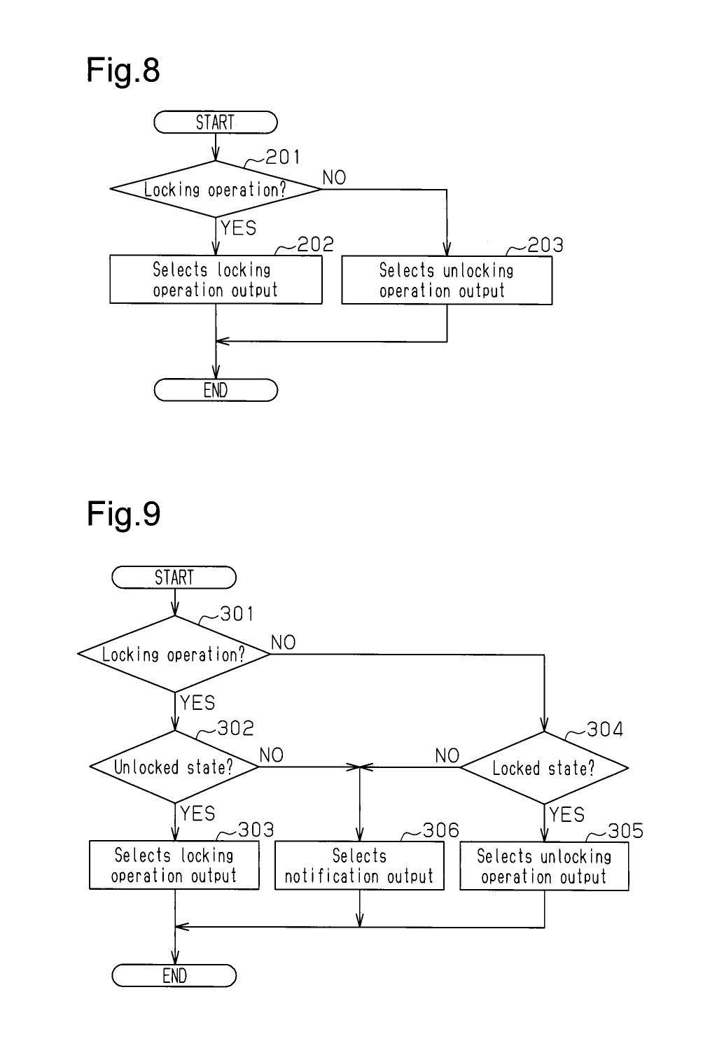

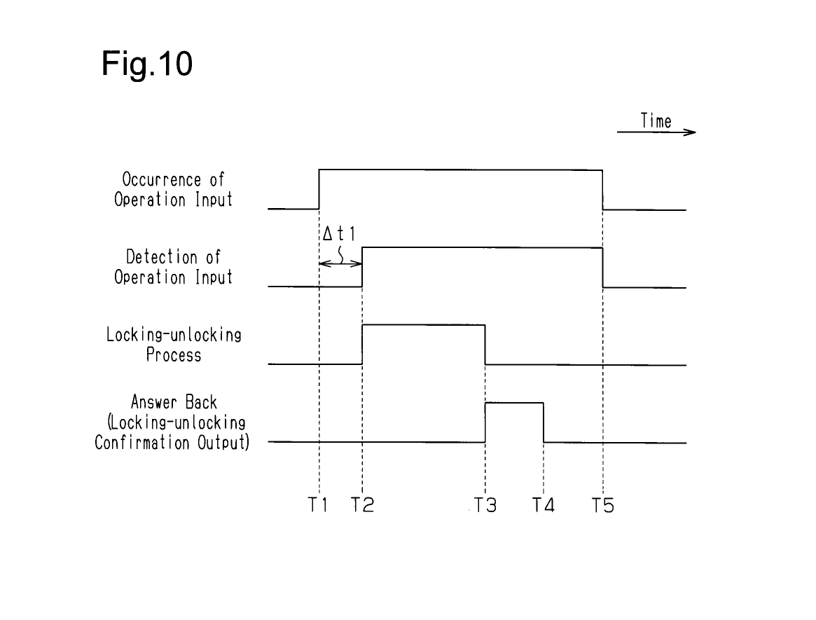

That is, for example, as shown in FIG. 8, in the operation confirmation output generating process (refer to step 106 of FIG. 5), the operation input ECU 21 determines whether the detected operation input is a locking operation (step 201). If the detected operation input is a locking operation (step 201: YES), the operation input ECU 21 generates locking operation confirmation output (step 202). If the detected operation input is not a locking operation (step 201: NO), that is, if the detected operation input is an unlocking operation, the operation input ECU 21 generates unlocking operation confirmation output (step 203).

Thus, the user can promptly confirm whether the operation input corresponds to a locking operation or an unlocking operation. This further improves the convenience for the user.

Furthermore, in a case in which the operation input ECU 21 is capable of identifying the locked-unlocked state of the vehicle door 1, the operation input ECU 21 determines whether the locking-unlocking operation indicated by the detected operation input changes the locked-unlocked state of the vehicle door 1. If the locked-unlocked state will not be changed, operation confirmation output indicating such information may be generated.

That is, for example, as shown in FIG. 9, in the operation confirmation output generation process (refer to step 106 of FIG. 5), if the detected operation input is a locking operation (step 301: YES), the operation input ECU 21 subsequently determines whether the vehicle door 1 is in the unlocked state (step 302). If the vehicle door 1 is in the unlocked state (step 302: YES), the operation input ECU 21 selects locking operation confirmation output (step 303).

In contrast, in step 301, if the detected operation input is not a locking operation (step 301: YES), that is, if the detected operation input is an unlocking operation, the operation input ECU 21 subsequently determines whether the vehicle door 1 is in the locked state (step 304). If the vehicle door 1 is in the locked state (step 302: YES), the operation input ECU 21 selects unlocking operation confirmation output (step 305).

Furthermore, in step 302 or step 304, if the locking-unlocking operation indicated by the detected operation input is the same as the locked-unlocked state of the vehicle door 1 (step 302: NO or step 304: NO), the operation input ECU 21 selects a notification output indicating such information (step 306). Generating the notification output indicating that “the operation input will not change the locked-unlocked state of the vehicle door 1” allows the user to promptly confirm such information.

1. An operation input confirmation device comprising:
an operation input section configured to be used for locking/unlocking a vehicle door;
an operation input detector, which detects occurrence of an operation input to the operation input section;
a locking-unlocking confirmation section, which generates a locking-unlocking confirmation output indicating execution of locking/unlocking corresponding to the operation input; and
an operation confirmation section, which generates an operation confirmation output indicating the occurrence of the operation input in response to the detection of the occurrence of the operation input without waiting for execution of locking/unlocking.

2. The operation input confirmation device according to claim 1, wherein the operation confirmation section generates the operation confirmation output in a different control manner depending on whether the detected operation input is a locking operation or an unlocking operation.

3. The operation input confirmation device according to claim 1, wherein the locking-unlocking confirmation section generates the locking-unlocking confirmation output after stopping the operation confirmation output.

4. The operation input confirmation device according to claim 1, wherein, when a locking-unlocking operation indicated by the detected operation input does not change a locked-unlocked state of the vehicle door, the operation confirmation section is configured to generate the operation confirmation output indicating such information.

5. The operation input confirmation device according to claim 1, wherein the operation input section is configured by using a capacitive touch sensor.

6. The operation input confirmation device according to claim 1, wherein the locking-unlocking confirmation section executes the locking-unlocking confirmation output at an interval after the operation confirmation output is stopped.

7. The operation input confirmation device according to claim 1, wherein the operation confirmation output is continued until the detected operation input is stopped.

8. A vehicle door handle device comprising the operation input confirmation device according to claim 1.

9. The vehicle door handle device according to claim 8, comprising:
a capacitive touch sensor serving as the operation input section; and
an oscillator serving as a confirmation output section, wherein
the touch sensor has a capacitive sensor electrode, and
the capacitive sensor electrode and the oscillator are formed integrally.

10. An operation input confirmation device comprising:
an operation input detector configured to detect occurrence of an operation input to an operation input section configured to be used for locking/unlocking a vehicle door;
a locking-unlocking confirmation section, which generates a locking-unlocking confirmation output indicating execution of locking/unlocking corresponding to the operation input; and
an operation confirmation section, which generates an operation confirmation output indicating the occurrence of the operation input in response to the detection of the occurrence of the operation input without waiting for execution of locking/unlocking.
